(19) United States
(12) Patent Application Publication
(10) Pub. No.: US 2019/0392959 A1
(43) Pub. Date: Dec. 26, 2019

(54) Predicting Multiple Nuclear Fuel Failures, Failure Locations and Thermal Neutron Flux 3D Distributions Using Artificial Intelligent and Machine Learning

(71) Applicant: Yaojun Sun, South Riding, VA (US)

(72) Inventor: Yaojun Sun, South Riding, VA (US)

(73) Assignee: Wuxun Technologies, Ltd.

(21) Appl. No.: 16/251,031

(22) Filed: Jan. 17, 2019

Related U.S. Application Data
(60) Provisional application No. 62/621,826, filed on Jan. 25, 2018.

(51) Int. Cl. G21C 17/108; G21C 17/06; G21D 3/04; G06N 20/00; G06N 5/04

(52) U.S. Cl. CPC G21C 17/108; G21C 17/063; G06N 5/04; G06N 20/00; G21D 3/04

(57) ABSTRACT

Most commercial power reactors in the world, so called second generation of nuclear power plants (NPP), were designed in 1960s and 1970s. Due to technology constrains, these NPP's nuclear fuel burnup data are calculated as a whole of a fuel assembly (FA) based on the total core power output during certain period of time and the theoretical physics calculation of the thermal neutron flux (TNF) distribution in the reactor core. This traditional burnup calculation based on theoretical TNF 3-D distribution for each FA in the core is far less accurate in term of pin-point burnup data along the entire length of a FA. Therefore, the most contribution factor to fuel failure event, e.g. the accurate burnup data at a fine grained location along a FA, could not be obtained by these existing methods and practice in these NPPs.

This invention applies the modern machine learning and artificial intelligent methods to provide a much finer-grained TNF 3D distribution prediction for these second generation NPPs. With this pin-point TNF data along each FA's length, the maximum burnup locations in the entire core can be determined. This will result a more accurate method for determine the fuel failure locations after fuel failure events.

### BACKGROUND

For current commercial nuclear power plants (NPP), due to many cross-impacted factors presented in determining nuclear fuel rod failures (FF) events, especially in cases of the smaller fuel rod leaking events, the traditional fuel failure analysis methods based on radioactive measurements in the primary coolant have shown increasingly uncertainties. This invention has applied modern artificial intelligent (AI) and machine learning (ML) technologies, which are very effective to resolve complicated issues with many variables in consideration based on large amount of related data, to determine FF events, their locations, and the core 3D thermal neutron flux (TNF) distributions. With the support of large amount of radioactive measurement data from many different kinds of nucleus, and the huge historical and real time reactor core's Distributed Control System (DCS) data from related fuel cycles, the inventions use other elements which are involved in the complicated total radioactive quantities, such as the release to birth rate ratios (RB) of certain featured fission isotope's, fast neutron flux (FNF) measurement data outside of the reactor core, DCS data and the calculated fuel burnups from each fuel assemblies. As a result, the invention has surpassed traditional FF analysis methods in term of accuracy in detecting FF events, multiple FF events in one fuel cycle, location identifications of the failed assemblies. The invention predicts the core thermal neutron flux 3D distributions more accurately than the traditional methods based on neutron physics theories. The inventions introduce the following concepts:
Data model with enhanced-domain-knowledges,
Creations of new variables as featured data for guided machine learning, and
Application of defined multiple coefficients in different data-model prediction processes.

The inventions combine “expanded data types” and “hybrid guided machine learning” methods to provide continuing self-learning mechanism of the applied data models and achieve more and more accurate predictions by the evolving data models. The inventions solve the difficult problems of detecting multiple and small FF events in a fuel cycle and locating the failed assemblies in such events. By comparing with the existing traditional physics-based detection methods, the invention improves the detection accuracy of multiple FF events greatly, and provides assembly level location information of the failed assemblies.

In the prediction of reactor core Thermal Neutron Flux (TNF) three dimensional (3D) distribution, the inventions use the historical and real time DCS streaming data, especially its fast neutron data measured outside of the reactor core. The historical and real time DCS data are used for each fuel assembly (FA) along its entire length. This allows the prediction data models to continue self-learning from the real time data and improve the accuracy over time.

The traditional methods to detect FF are based on the analysis to the radioactive measurements from the samples from the primary coolants. These methods are physics-based. However, the radioactive elements and nucleus (fission isotopes) measured in the primary coolants are more than 30 types. Because the radioactive levels (measured data) of these isotopes are depend on many factors, such as reactor power, broken rod cladding crack or hole sizes and shapes, the location of the crack along the fuel rods, the uranium particles and residues on the surface of fuel assembles, etc., the physics analysis methods are abstracted mathematical functions and are impossible to consider all related impact variables. These are the complicated facts which influence all the possible FF causes when trying to determine if a FF accident occurs. Due to the above complicated contributions to the radioactivity levels of these isotopes measured from its coolant samples, these traditional, nuclear physics-based methods have shown consistent uncertainties when the failed fuel gas leaking is small. On the other hand, a NPP needs to identify or locate the failed fuel assemblies (FFA) and removes them during the scheduled shutdown periods for reloading its fuels. Therefore, the abilities of accurately detecting and locating of all the failed fuel assemblies in the previous fuel cycle are very important in order to optimize the offline schedules and to reduce the workloads during shutdown periods for a NPP. Obviously, accurate detection of all FF events and pin-point the locations of the failed assemblies also help to identify the root cause of these FF events. Thus, the invention helps the nuclear power industry to reduce and eventually, to eliminate the FF accidents in the future.

In order to locate FFAs, the accurate liner burnup data for each FA along its entire length are the key identifier. However, current NPPs do not provide adequate thermal neutron flux (TNF) sensors in the core. Due to the straight relationship between TNF and FA's burnup, the absences of fine-grained TNF info of each FA in the reactor core make the current prediction approaches (coarse-grained) of a FA's burnup with many uncertainties. This reactor physics method also has complicated challenges in the real world NPP by:
Temperature (or doppler effects)
Strong spatial discontinuities between materials (Water next to Zr and UO2)
Neutron scattering is non-linear in energy, angle and space
Time dependence (Neutron population, Material properties and compositions)

These uncertainties result the burnup calculation errors with about 3 percent of Root Mean Square (RMS) for 3-D reaction rates in PWR and 3-6 percent for BWR. The 3 to 6 percent RMS in 3-D reaction rates makes it impossible to pin-point the exact FA out of the same batch FAs.

### SUMMARY OF THE DISCLOSURE

The summary of this invention include the followings:
1. By collecting reactor's DCS related historical and online real time data, provide a new and more accurate way of predicting thermal neutron flux distribution along a FA in the reactor core using big data training and machine learning method. This approach generates the distinct burnup data predicted for each FA continuously during reactor operation.
2. For each FA in the reactor core, a method to quantify its accumulating contribution of total radiation per thermal neutron flux distribution data based on the above approach is invented to represent the FA's burnup calculation along its entire length.
3. Invented a detection and prediction method for nuclear fuel rod failures location through data training of machine learning per DCS's data training.
4. By using the new FA burnup data calculation method to calculate each FA for its entire length in its all fuel cycles, the worst burnup part of this FA is used to predict its FF event. Thus, a new method of locating the failed assemblies with accuracy of reactor core 3D dimensions is invented.
5. A self-learning and data model improving mechanism is invented by altering the wrongly-predicted events and using the corrected data as new training data set for updating the machine learning data models to improve the future 3D TNF distribution and burnup predictions.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

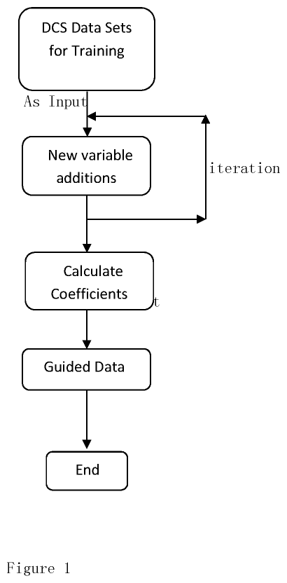

FIG. 1 depicts process of creation of the Guided Data from historical DCS data of a reactor to be used for Machine Learning in this invention:
1) Select related names in DCS data as input data for machine learning.
2) Through different iteration of data item selection process, if an addition of a data item improves the data model, the data item can be added to the training data set.
3) Use the selected data items to calculate different impact coefficients to generate the guided data set for data training.

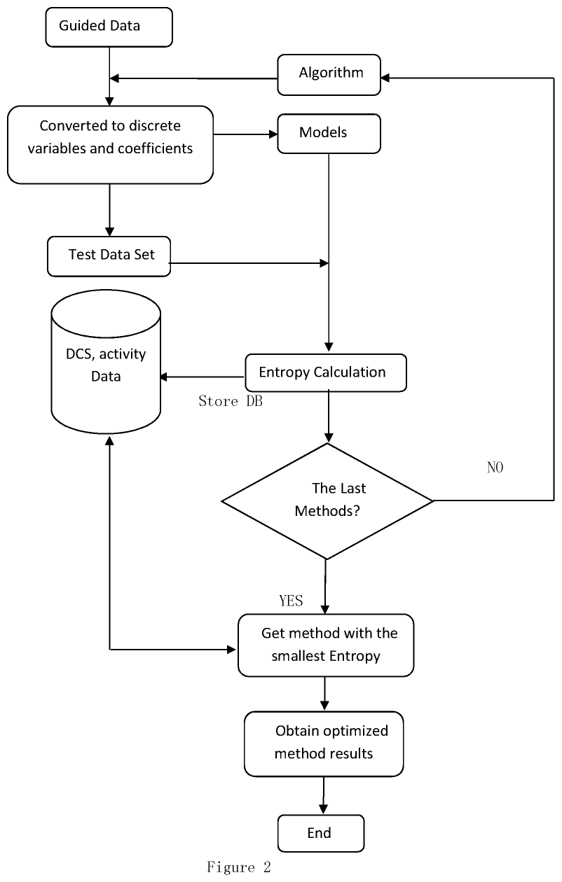

FIG. 2 is the logic flow to find the prediction models from guided data:
1) Use Guided data from FIG. 1 as initial input data.
2) Calculate the input data and convert them to test data of discrete variables and coefficients as defined by this invention.
3) Use an initial data model and guided data to calculate the difference with the test data (entropy calculation), then store the interim results to bid data database.
4) Iterating the above calculation using all other data models.
5) Find the best data model with the smallest entropy values as the prediction model.

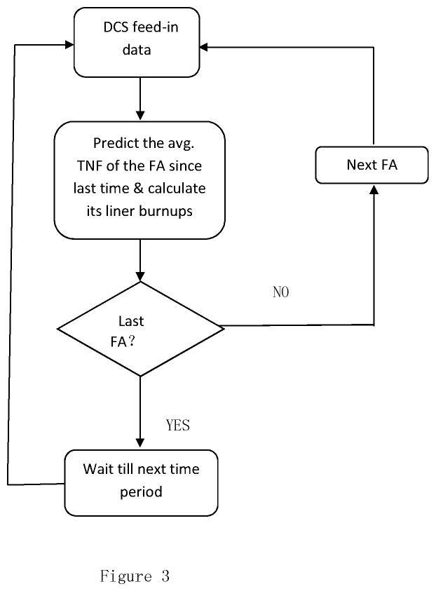

FIG. 3 is the processes of predicting the reactor core thermal neutron flux (TNF) distribution along a specific fuel assembly (FA) for its entire length:
1) Using real time DCS data as input data streams.
2) Use the best prediction model to predict the TNF value along the entire FA length.
3) Convert FA's TNF value to burn up data for the FA along its entire length.
4) Iterate through all FAs in the core.
5) Accumulating the predicted burn up data till the next time period.

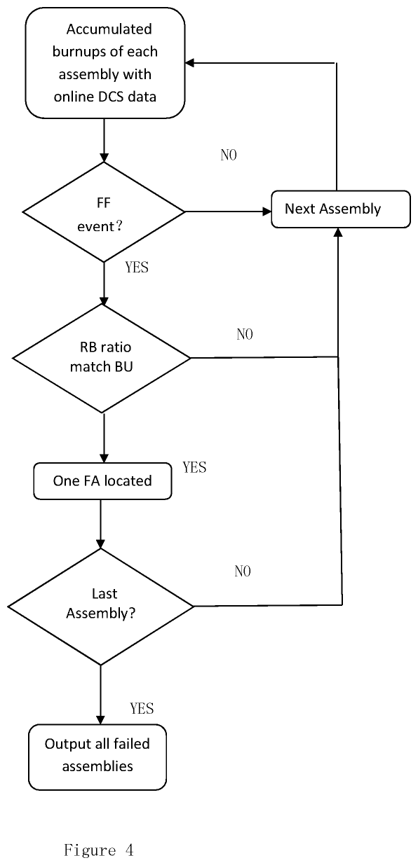

FIG. 4 depicts the method of finding the locations of all failed FAs.
1) Input real-time core DCS stream data and the predicted burnup prediction from the best prediction data model.
2) If FF events predicted in the core, find out release to birth rate ratios (RB ratios) of certain featured fission isotope's, with the fast neutron flux measurement data outside of the reactor core in the DCS.
3) If the point's RB matches its's burnup value, then the FF location is identified.
4) Iterate through all FAs in the core to find out all FF locations using the above steps.

### DETAILED DESCRIPTION OF THE INVENTION

In traditional FF detection approaches, the first step to estimate reactor fuel reliability is to analyze the radioactivity of samples from the primary coolant. By monitoring the radiation measurements and quantities of fission products and isotope nucleus from the by-pass system of the primary coolant, nuclear power plant workers can obtain useful information about the fuel elements and performance during reactor operations. The measured radioactivity data from different fission isotopes in the primary coolant samples can help to detect the cycles and patterns of fuel failures, to estimate the quantities and types of fuel failures, and to predict the possibilities of fuel failures. Although the radioactivity levels of the primary coolants do reflect the overall fuel behaviors, and this traditional method of this radioactivity analysis are widely used in many areas of nuclear power reactor operations, the radioactivity analysis methods are not the best suit to quantify the fuel failure identification and could not be used to locate the FFAs. The main reason is that the quantities and types of radioactive isotopes and fission products are many and depends on various factors, such as the locations and sizes of the cracks on the fuel rods. The uncertainties to detect fuel failures by using traditional radioactivity analysis also include the following issues;
1. There are many possible causes of fuel failures.
2. The reactor power level is another huge factor contribution to total radioactivity.
3. The local heat generation rate (LHGR) of the fuel assembles and isolated uranium in the coolants impact the radioactivity levels.

Therefore, the traditional and simple analysis of radioactivity from the primary coolants has great uncertainties to detect fuel failure accidents. Especially when the failed fuel rod gas leaking is small, the traditional radioactivity analysis method is not effective to detect such small fuel rod failure events.

With the breakthroughs of artificial intelligent technologies in many areas recently, this invention adopts new deep machine learning methods to detect the reactor fuel failure events. In this area, the problems involve many variables, complicated time and space aspects, and many real-world engineering problems. With the support of large quantities of reactor operating DCS data and radioactive measurement data, the machine learning approaches can be very effective to solve such problems. These kind of problems are extremely hard to be abstracted to simpler mathematical, physics-based equations, such as the reactor fuel failure detection problems.

With the machine learning technologies, such as convolutional neural network (CNN), based on their shared-weights architecture and translation invariance characteristics, by using large amount of related reactor's DCS historical data sets, the modern artificial intelligent methods perform many iterations, optimization and convergence to the suitable data models. Then, the new test data sets are used to calibrate and verify the prediction data models for future data model optimizations. With the help of modern computing capabilities, the final data models show very accurate and positive results to detect real-world reactor fuel failure events by inputting real time reactor's radioactivity measurement and online real time DCS data.

This invention uses different machine learning algorithms to solve the difficult tasks of detecting multiple reactor fuel failure events during a one fuel cycle. Combining with real time DCS data, and the new approaches of predicting the FA burnup values of each fuel assembly in the reactor core based on predicted core thermal neutron flux 3D distribution, each FA's burnup data alone its length are compared with the indicator of the corresponding isotope's RB ratio to identify if the location along the FA. The matched point, or location of the FA is predicted as the failure location of the FF.

The detailed invention stated as followings:
A. Apply the concepts of assistant variables and coefficients (AVC) from the guided training data sets. The conversion and calculation of these assistant variables, coefficients and factors can be linearly or not to some of the variables in the training data sets. These AVCs include, but not limited to:
   I. Time series variable (TS); “TS” is defined to reflect the impact by accumulating fuel burnups. The “TS” will normalize the quantification of the impact of fuel burnups to FF events. Per reactor operation full-power days, one full-power day equals to quantity of “1” of the TS value. The “TS” value is accumulated with each reactor full-power day.
   II. Power change variable (PC); The “PC” represents the impact of reactor power change rate to the fuel failures in an accumulated way. The rate of reactor power level changes, RC, is defined as the absolute value of (W2−W1)/(T2−T1), where T represents time, W represents power level, 1 represents the time before and 2 after the changes. PC is also calculated accumulatively of the RCs.
   III. Number of fuel cycles-month variable (FC); Based on the largest accumulated number of months the fuel assembles stayed in the core, such as those in their third cycle, and the number of these fuel assembles, let “X1” represent the number of full-power months during the first cycle, “X2” during the second cycle. Thus, the “FC” is calculated as:
      (the number of full-power months of current cycle+X1+X2)*(total number of fuel assembles in their third cycles in the core, e.g. those the most used FAs in current core), where * means multiplication. Because of the multiplication, the total number of fuel assembles in their third fuel cycle plays an important role in “FC”'s calculation.
   IV. Total cycle coefficient (TC); “TC” reflects the operation age of a reactor. Starting from a value “Y0” for the new reactor, each additional cycle would add a fixed cycle value “Yi”. Thus, at the “n” cycle, the “TC” is calculated by: (Y0+n*Yi).
   V. FF history coefficient (H); “H” reflects the impact of all historical FF events of a reactor. “H” is calculated a linearly based on the total accumulated number of FFs of a reactor.
   VI. New Reactor coefficient (N); “N” is a fixed number representing the high likely hood of FF events for newly constructed reactors. Its value will depend on the type and the maturity of a reactor.
   VII. Brocken factor (B); “B” is defined as the continuing FF status after a FF event is detected.
   VIII. Continuation factor (C); “C” represents the number of showing contiguous FF results from a sequence of input data. Based on the sensitivity of the data models for each reactor, the “C” factor could be different.
   IX. The same reactor type factor (S), The “S” is a factor considered in the training data sets from different, but the same type of reactors. “S” is also a relationship factor for the itself, the same type, the same cycle, in the same plants, etc. “S” has a value as less or equal “1”, where “1” represent the same reactor.
B. The methods of data analysis and machine learning: For smaller amount to training data sets, different machine learning approaches are used to different training data. Based on the different results of each test data set and methods used, the single entropy of each method, the accumulated entropy and total entropy are calculated and compared to filter out the best suit and optimized data model. The more complicated algorithm used, the more training data are needed. Thus, the most optimized method to generated data model may be varied depend on the amount of available training data sets. The algorithm and methods to be selected including: Special algorithm, such as our GAI; other algorithms, such as SMO, Logistic, Simple Logistic, SVM and FCNN, etc.
C. The method to determine FF: The method is called Weakening Low-Contributor Modeling (WLCM). It is shown in FIG. 2 of this invention. The detailed steps are:
   I. Step 1: pre-processing the training data sets: For a given training data set, based on the description in 1) and 2) of A stated above, generate the assistant variables of TS and PC. Use generated TS and PC values along with other variables in the training data sets to perform the fuel failure detection. The detection steps are as following:
      1) Calculate all AVCs defined in A and form the total factor “Fa”;
      2) Use the “Fa” to correct the TS and PC values, which are part of the training data sets.
      3) Per suitable value range of each variable in the original training data set, convert the original values of each variable to discrete data type.
      4) Calculate and store the current minimal entropy value of each variable “Hi”, and the separate point, as well as the total “Hi” of all variables, that is “H-sum”.
      5) Calculate and store the entropy of the entire training data set, composed of original data set and the TS and PC.
      6) By varying the combination and sequence of the training data sets, and using the every algorithm available to generate the machine learning data models.
   II. Step 2: Applying the test data set and the new AVC values, verify and adjust the generated machine learning data models. When using the test data set to verify the generated models, the following operations are conducted to the false detection data:
      1) Per calculated minimum entropy Hi and its separation point of each variable in the test data set obtained in step 1, compare the location of this test data point. If it falls in the wrong range of categorization of fuel failures, a new weaken contribution variable factor, “Ri” is introduced.
      2) For every calculated “Ri” of each variable in the test data set in 1), multiply it to the value of the corresponding variable in the test data set, redo the Step I to obtain the new machine learning data models.
   III. Step 3: repeat above step 1 and 2, till the minimum entropy is achieved and no false FF detection results in the process.
D. The combined methods of FF detection and prediction: Refer to FIGS. 3 and 4 for detailed description in the followings:
   I. When detecting FF using real time data points, if the calculated results of “no” failure appear “N” times continuously within certain probabilities X (such as 10 times less than 60%”, where N=10 and X=60%), if the next data point shown the same results, that is continues N+1 times of “No failure” results with less than X probabilities, the prediction of FF event can be made with high probabilities.
   II. If there are accumulative “M” times of Failure results with higher than “Y” probabilities for real time data points from the model, such as accumulating to times of higher than 80% probability predicted results by the model, where M=20 and Y=80%, the prediction of FF event can be made with high probabilities.
   III. The above N, X and M, Y values can be vary depend on the types of reactors and other specific facts, such as fuel manufactures and locations of the plants, etc.
E. The methods of predicting TNF 3-D distribution for each FA in the reactor core:
   I. Using all DCS core-related historical and real time data, such as power, core temperatures at all sensor locations, etc., and the fast neutron flux data outside of the core, generate a data model for predicting the TNF 3D distribution of a FA.
   II. Calculating the initial TNF estimation at the FA by a coarse-grained physics method and the deviation between the two methods.
   III. Iterating all FAs for the about two steps to summarize to whole core power by all FA's TNF and their other related physics properties, such as assumed burnups, fission isotopes enrichments, etc.
   IV. Comparing the two summarized whole power values to the DCS's output power values, if the DCS-based results is worse than that of the physics-based, adjusting the DCS-based prediction data model till the result is better than physics-based calculation and the difference from true DCS power is less than a predefined margin.
F. The methods of locating the failed FA:
   I. With the above burnup data of each FA, when a FF event is predicted, the corresponding isotope RB ratio is calculated.
   II. By matching the RB ratio with burnup value, identify the FA.
   III. Iterating all FAs and output each FA with the matched burnup data to the RB ratio.

This invention is based on real-time DCS data stream, including radioactive isotopes and fast neutron flux data. A big data processing platform and software programs are used to implement the algorithms and logics. The invention can be used as either standalone system inside the nuclear power plant's premises with the real time DCS data stream as inputs, or other reactor radioactive data collection mechanism as input. It also can be used as a web service from a service host location by remotely input real time radioactive data measured by the nuclear power plants.

1. Invent a new detection and prediction method for nuclear fuel failure events and the location of failures along a FA linearly.

2. In the above claim 1, invent multiple impact factors and conversion assistant variables to consider the FF's impact by the FA's burnup. The longest FAs in the core are used to calibrated the conversion factors.

3. In above claim 1, a method of identifying the locations of all failed FAs with real time DCS data matching to the radioactive data used to predict the FF events. In this process, the predicted TNF 3-D data in claim 3 are converted into accumulated burnup data for every point of all FAs inside the core.

4. Invent a method of calculating TNF 3-D distribution based on historical and real time rector's DCS data to achieve finer grained TNF results better than physics-based methods. With real time DCS data as input, the TNF prediction accuracy will constantly be improved through machine self-learning.
